(19) United States
(12) Patent Application Publication
(10) Pub. No.: US 2015/0280634 A1
(43) Pub. Date: Oct. 1, 2015

(54) ELECTRO-MAGNETIC TRANSDUCER AND VIBRATION CONTROL SYSTEM

(71) Applicant: ASK INDUSTRIES SOCIETA' PERAZIONI, Monte San Vito (AN) (IT)

(72) Inventor: Maurizio Servadio, Monte San Vito (AN) (IT)

(21) Appl. No.: 14/440,404

(22) PCT Filed: Nov. 5, 2013
(86) PCT No.: PCT/EP2013/073082

§ 371 Date: May 4, 2015

(30) Foreign Application Priority Data
Nov. 8, 2012 (IT) AN2012A000146

(51) Int. Cl. H02P 31/00

(52) U.S. Cl. CPC H02P 31/00

(57) ABSTRACT

An electromagnetic transducer is disclosed including a ring magnetic assembly, a first coil disposed in the magnetic field generated by the magnetic assembly, such that the first coil reciprocally moves with respect to the magnetic assembly, at least one elastic suspension-connecting the magnetic assembly to the first coil to allow for reciprocal movement between the first coil and the magnetic assembly, a control coil connected to the magnetic assembly by an elastic suspension to allow for reciprocal movement of the control coil with respect to the magnetic assembly, a vibrating surface connected to the first coil or the magnetic assembly or the control coil in order to vibrate, and an electronic control to control an excitation current of the control coil in order to generate a mechanical force adapted to control the mechanical vibration of the vibrating surface.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present patent application for industrial invention relates to an electromagnetic transducer with vibration control system that can be applied to any vibrating surface. In particular, the invention relates to electromagnetic transducers with thin ring and high travel.

2. Description of Related Art Including Information Disclosed Under 37 CFR 1.97 and 37 CFR 1.98.

A high-travel, thin electroacoustic transducer is disclosed in patent application PCT/EP2012/060772 in the name of the same applicant.

The known types of thin transducers are impaired by drawbacks due to the noise generated by the vibrations caused by the movement of the coil with respect to the magnetic group or vice versa.

The purpose of the present invention is to eliminate the drawbacks of the prior art by providing an electromagnetic transducer with a low thickness vibration control system, with mobile parts capable of making high travels compared to the total thickness of the transducer, which allows for controlling the vibrations of the vibrating surface without increasing the total thickness of the transducer.

Another purpose is to provide such a vibration control system that is able to dissipate a large amount of heat, at high power, reach high masses and also generate large mechanical forces to control strong vibrations.

Another purpose is to provide such a vibration control system that is simple, reliable, inexpensive, easy to make and requires the lowest number of non-active added masses.

Another additional purpose is to provide such a vibration control system that is able to eliminate any type of iron magnetic circuit (polar expansions, plates, T-Yokes and the like).

Another additional purpose is to provide such an electromechanically powerful vibration control system that is light and sturdy.

### BRIEF SUMMARY OF THE INVENTION

These purposes are achieved according to the invention with the characteristics claimed in independent claim 1.

The electromagnetic transducer of the invention comprises:
a ring magnetic assembly that generates a magnetic field,
a first coil disposed in the magnetic field generated by the magnetic assembly, such that the first coil can move with respect to the magnetic assembly and vice versa,
at least one elastic suspension that connects the magnetic assembly with the first coil to allow for mutual movement between the magnetic assembly and the voice coil,
a control coil connected to the magnetic assembly by means of an elastic suspension to allow for reciprocal movement of the control coil with respect to the magnetic assembly,
a vibrating surface connected to the first coil or the magnetic assembly or the control coil in order to vibrate, and
an electronic control to control an excitation current of said control coil in order to generate a mechanical force adapted to control the mechanical vibration of said vibrating surface.

### BRIEF DESCRIPTION OF THE DRAWINGS

Further characteristics of the invention will appear clearer from the detailed description below, which refers to merely illustrative, not limiting, embodiments, illustrated in the attached drawings, wherein:

FIG. 1 is an axonometric cross-sectional view of the electromagnetic transducer of the invention, applied to a loudspeaker;

FIG. 2 is an axonometric exploded view that partially shows the various parts of the transducer of FIG. 1;

FIG. 2A is an enlarged perspective view of a single magnet of the magnetic assembly of FIG. 2;

FIG. 2B is a sectional view that shows a first assembly step of the magnets in the enclosure of the magnetic assembly;

FIG. 2c is a diagrammatic sectional view that shows the disposition of the control coil with respect to the magnetic fluxes of a magnetic assembly having height higher than width;

FIG. 2d is the same view as FIG. 2c, except for it shows a magnetic assembly with height lower than width;

FIG. 3 is an axonometric view of the vibration control system of the invention composed of control coil-suspension-magnetic assembly of the transducer of FIG. 1;

FIG. 4 is the same view as FIG. 3, except for it shows an extra-travel of the coil with respect to the magnetic assembly;

FIG. 5 is a sectional view that shows the disposition of the lines of the magnetic field on the control coil of the vibration control system of FIG. 3;

FIG. 6 is the same view as FIG. 5, except for it shows the concentration of the magnetic field obtained with a highly magnetic permeable ring disposed in the proximity of the control coil;

FIG. 7 is the same view as FIG. 3, except for it shows a different embodiment of the vibration control system comprising a double symmetric suspension for protection of the control coil;

FIG. 8 is a partially interrupted sectional view that shows the transducer of the invention, wherein the vibrating surface is connected to the magnetic assembly; and

FIG. 9 is the same view as FIG. 8, wherein the vibrating surface is connected to the control coil.

### DETAILED DESCRIPTION OF THE INVENTION

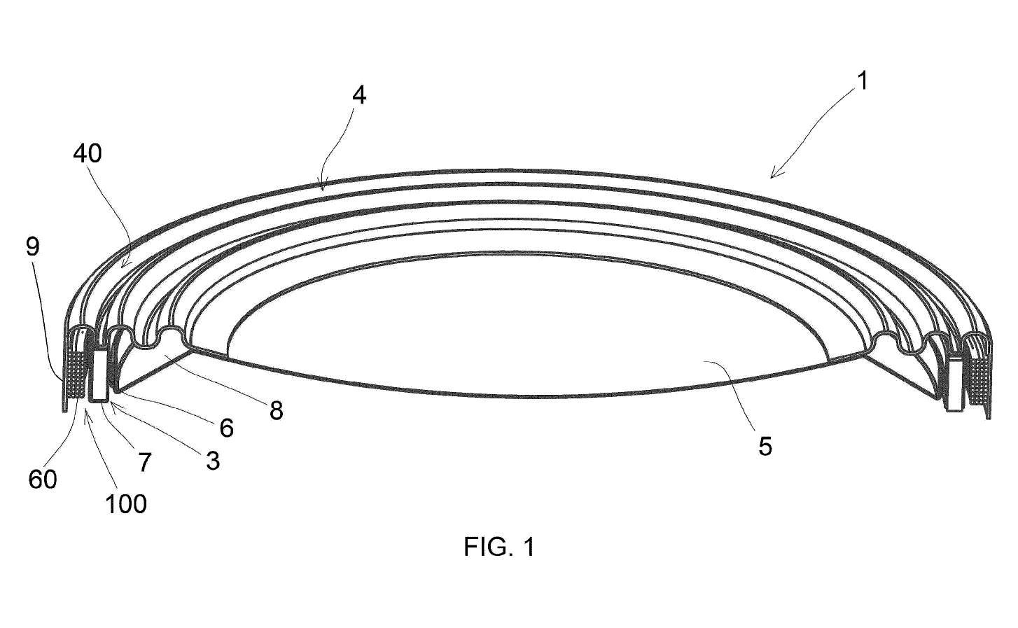

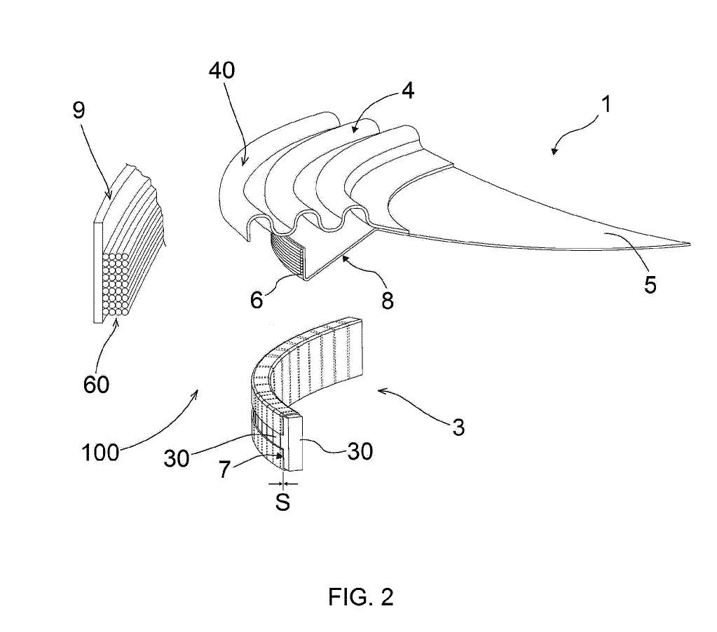

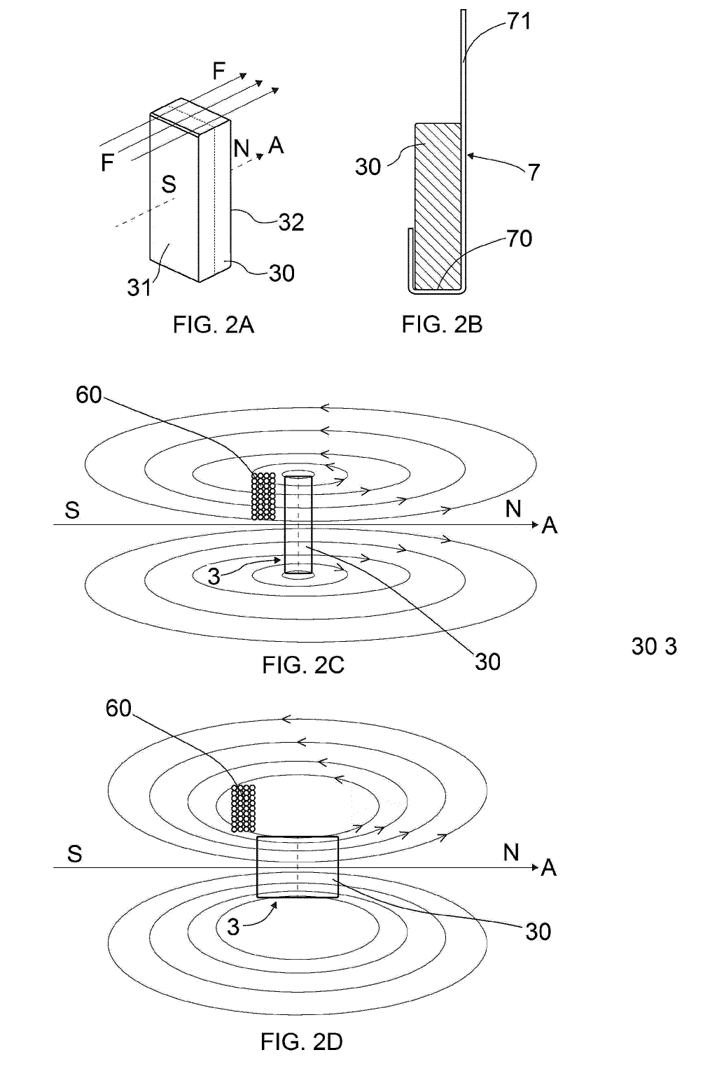

Referring to the figures, the electromagnetic transducer of the invention is disclosed, which is shown in FIGS. 1 and 2 and generally indicated with reference number (1). Hereinafter, the terms “lower, upper, horizontal and vertical” refer to the disposition of the figures.

Referring now to FIGS. 1 and 2, the transducer (1) comprises a ring magnetic assembly (3), a coil (6) connected to a vibrating surface (5) and an elastic suspension (4) connecting the magnetic assembly (3) to the coil (6). In this way, the coil (6) is immersed in the magnetic field generated by the magnetic assembly (3). When the electrical current passes through the coil (6), the coil (6) generates a magnetic field and the coil (6) moves with respect to the magnetic assembly (3), making the vibrating surface (5) that is connected to the coil (6) vibrate.

In such a case, the vibrating surface (5) is an acoustic membrane of a loudspeaker that emits sound. Therefore, the coil (6) is a voice coil.

Advantageously, the coil (6) is supported on a support (8) connected to the vibrating surface (5).

FIGS. 1 and 2 show an embodiment of the invention, wherein the magnetic assembly (3) is adapted to be fixed to a fixed surface, therefore the coil (6) moves with respect to the magnetic assembly (3).

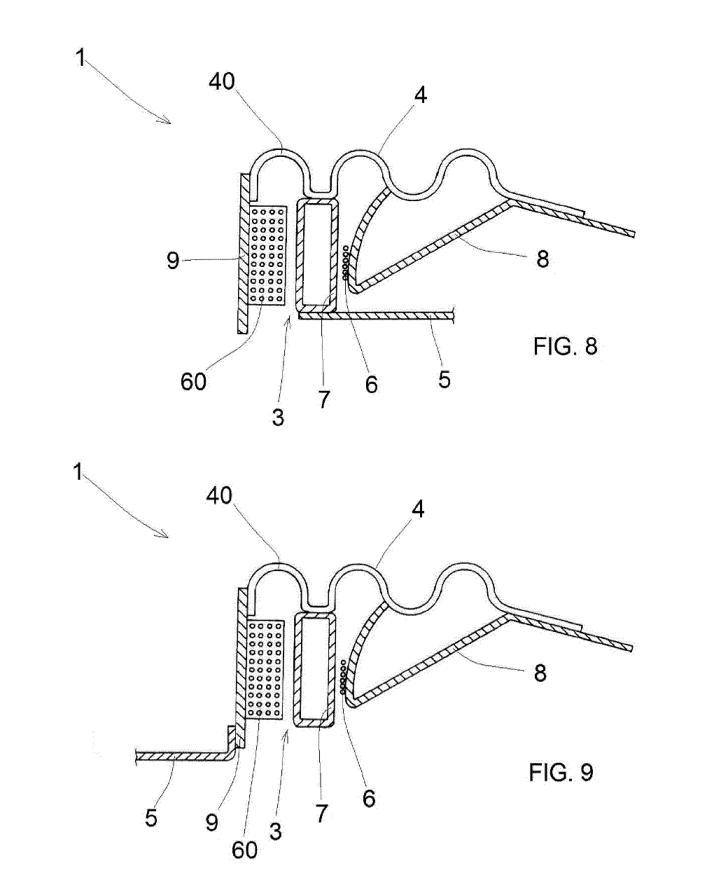

Nevertheless, as shown in FIG. 8, according to the transducer of the invention, the coil (6) is fixed to a fixed surface and the magnetic assembly (3) moves with respect to the coil (6). In such a case, the magnetic assembly (3) is connected to the vibrating surface (5) whereon vibrations must be controlled.

According to the invention, in order to control the vibrations of the vibrating surface (5), a second coil (60), hereinafter called control coil (60), has been introduced. The control coil (60) is connected directly to the magnetic assembly (3) by means of an elastic suspension (40). In FIGS. 1 and 2, the elastic suspension (40) that connects the control coil to the magnetic assembly is illustrated as a portion of the elastic suspension (4) that connects the magnetic assembly (3) to the support (8) of the first coil (6). Nevertheless, the elastic suspension (40) that connects the control coil to the magnetic assembly can be a second suspension that is separate and independent from the elastic suspension (4) that connects the first coil (6) to the magnetic assembly (3).

Advantageously, the control coil (60) and its elastic suspension (40) are shaped as a thin annular crown in such manner to have the smallest acoustically radiant surface to prevent spurious generation of acoustic signal.

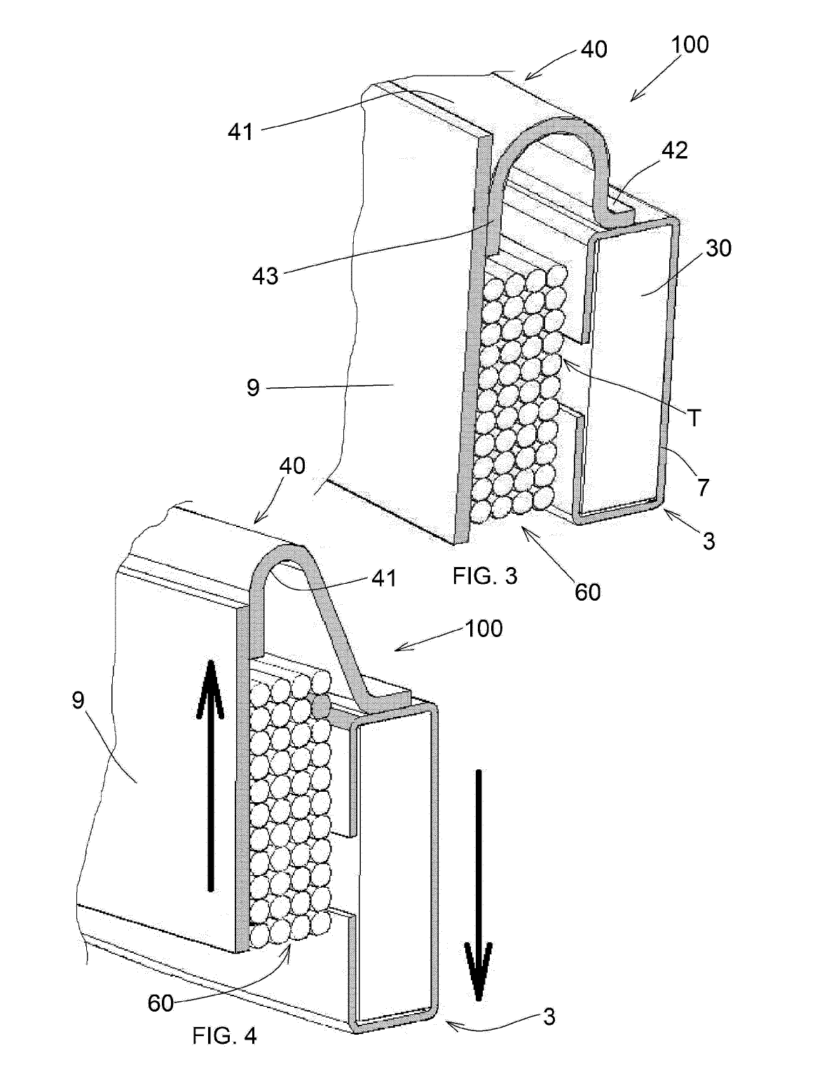

It must be considered that the control coil (60), the elastic suspension (40) and the magnetic assembly (3) form an autonomous vibration control system, which is globally illustrated in FIGS. 3-7 and indicated with reference numeral (100).

Although FIGS. 1 and 2 show the vibration control system (100) applied to the electroacoustic transducer (1) wherein the vibrating surface (5) is connected to the first coil (6), it is understood that the vibration control system (100) can be applied to any vibrating surface (5) connected either directly or by means of elastic suspensions to the magnetic assembly (3) (as shown in FIG. 8) or to the control coil (60) (as shown in FIG. 9).

When the electrical current passes through the control coil (60), it moves axially in the magnetic field generated by the magnetic assembly (3), therefore the assembly formed by the control coil (60) and the suspension (40) starts vibrating with an oscillatory motion that stores mechanical energy, proportional to the oscillation width, to the total mass put in oscillation and consequently to the current that circulates in the control coil (60) that allow for controlling the vibrations of the vibrating surface (5).

The excitation current of the control coil (60) is controlled by an electronic control in accordance to the vibration of the vibrating surface (5).

Such a vibration control system can be of active type—and in such a case a current generator is provided to feed the control coil (60)—or passive type—and in such a case the excitation current of the control coil (60) is a current induced, for example, by the magnetic field generated by the first coil (6).

The control coil (60) is provided in opposite position with respect to the voice coil (6) with respect to the magnetic assembly (3). In view of the above, if the voice coil (6) is disposed inside the ring of the magnetic assembly, the control coil (60) is disposed outside the ring of the magnetic assembly and vice versa.

Referring to FIG. 2, the magnetic assembly (3) comprises a plurality of magnets (30) that are contained inside an enclosure (7).

Referring to FIG. 2A, each magnet (30) has two opposite sides (31) and (32), wherein the south pole (S) and north pole (N) are provided. Therefore, the magnet (30) has a horizontal magnetic axis (A) that extends from the south pole to the north pole and therefore comes out of the north pole. The magnet (30) has axial anisotropy. In view of the above, when the magnet (30) is magnetized axially, lines of magnetic flux (F) are generated that are mutually parallel and parallel to the magnetic axis (A).

The magnets (30) can be made of any magnetic material, such as rare earths, in particular neodymium or ferrite or magnetic alloys. The magnet (30) can be composed of a block with any shape, preferably parallelepiped.

The proportions of the parallelepiped magnet (30) can change according to the specific shape of the magnetic field to be obtained. FIGS. 2C and 2D are a qualitative view of the lines of magnetic flux on the central section of magnets with parallelepiped shape with different geometric proportions. The different route of the flux line permits to be advantageously chosen to obtain different dynamic characteristics of the transducer.

For illustrative purposes, in FIG. 2C the control coil (60) can obtain a vertical linear range lower than the proportion shown in FIG. 2D, because in FIG. 2C the flux lines invert their direction prematurely and, although it has a much lower intensity than the main flux, the inverted flux can be used as a gradual electromagnetic brake in special situations. Instead, in FIG. 2D, the control coil (60) can make higher vertical linear travels, permitting the maximum travel/thickness ratio.

So, the magnets (30) can be easily disposed side by side in any configuration. Therefore, the magnetic domains and the magnetic flux lines of a magnet can be parallel or inclined with respect to the magnetic domains and the lines of magnetic flux of the adjacent magnet, in conformity with the fact that the magnets are inside the enclosure (7) in a linear or curved configuration.

The low-thickness enclosure (7) has a ring shape, not necessarily circular. The term “ring” indicates a ring of any shape, for example circular, elliptical, rectangular or the like. The enclosure (7) comprises an annular seat (70) wherein the magnets (30) are disposed side by side. When the magnets are disposed in the annular enclosure (7), the axes of the magnets (30) are directed towards the center of the ring.

The enclosure (7) can be made of any rigid, non-ferromagnetic material, such as plastics or a magnetic, diamagnetic or paramagnetic metal. The enclosure (7) must have a sufficient thickness to support the magnets and act as self-standing structure. At the same time the thickness of the enclosure (7) must not be excessive in the region facing the control coil (60) in order not to cause spacing such that the magnetic flux cannot be used, therefore impairing the performance of the vibration control system.

Advantageously, the enclosure (7) can be realized with a non-magnetic, yet electrically conductive material, to eliminate the parasite currents that are generated during the operation of the transducer. In such a case, if the thickness of the enclosure (7) is suitable, a significant counter electromotive current is generated inside it, behaving like a short circuit ring or Kellogg ring that controls the mechanical dampening of the system and can be advantageously used to control the distortion effects at low frequencies caused by the large relative motion between the voice coil (6) and the magnetic assembly (3).

Referring to FIG. 2, advantageously the thickness (S) of the enclosure (7) is selected from 0.1 to 1 mm. Preferably, the enclosure (7) is made of a metal sheet, for example copper, aluminum or silver, which is suitably folded to contain the magnets that, once they are magnetized, would tend to reject each other, but are instead firmly held in their housing by the special configuration of the enclosure (7), even without the use of adhesives.

Referring to FIG. 2B, the enclosure (7) is initially shaped as a sheet metal folded in L, in such manner to generate a seat (70) where the magnets (30) are disposed side by side. In this step the magnets (30) are not magnetized yet.

The magnets (30) can fall by gravity into the seat (70) of the enclosure or the magnets (30) can be glued or welded on a flexible strip and then inserted into the enclosure (7). The magnets (30) can be glued mutually or to the sheet metal of the enclosure.

Successively, one end (71) of the sheet metal is folded above the magnets (30) in such manner to wrap up the magnets (30), at least partially.

In this way, a magnetic assembly (3) is obtained, which is sturdy, rigid and non-deformable, which can act as self-standing structure. In fact, if the magnetic assembly (3) is fixed to a fixed surface, the enclosure (7) is also a support structure.

Instead, if the first coil (6) or the control coil (60) is fixed to a fixed surface, and the magnetic assembly (3) is adapted to move, the enclosure (7) only acts as structure to contain the magnets.

Advantageously and alternatively to the aforementioned methods, the magnets (30) can be inserted inside a mold and the enclosure (7) is molded directly on the magnets (30), using the so-called co-molding technique, of known type and therefore not explained in further details.

After obtaining the magnetic assembly (3), magnetization of the magnetic assembly (3) is carried out with a magnetizer of known type, such that each magnet (30) is axially magnetized. Such magnetization is carried out for parts of the magnetic assembly (3), by means of standard magnetizers, regardless of the size and shape of the magnetic assembly (3).

Referring to FIG. 3, the elastic suspension (60) that connects the magnetic assembly (3) to the control coil (60) has an annular shape and comprises at least one undulated loop (41) dispose between an internal peripheral border (42) and an external peripheral border (43). The external peripheral border (41) of the suspension is fixed to the enclosure (7) of the magnetic assembly.

The control coil (60) is supported by the support (9) composed of a rigid element, preferably made of sheet metal. Advantageously, the support (9) of the control coil is made of non-ferromagnetic material and has low thickness, for example lower than 1 mm.

The support (9) of the control coil has an annular shape. The control coil (60) is fixed to the internal surface of the support (9) and the external border (43) of the elastic suspension (40) is fixed to the internal surface of the support (9) above the control coil (60).

The support (9) is disposed externally around the magnetic assembly in such manner to generate an air gap (T) wherein the magnetic field generated by the magnetic assembly (3) is extended. The control coil (60) is disposed on the support (9), such that it is situated in the air gap (T). The control coil (60) can be wound directly or integrated in the support (9) in such manner to generate a multi-turn coil cemented to the support (9).

The vibration control system (100) provides for positioning the control coil (60) in a peripheral region of the transducer that has never been used so far. This allows for making the control coil (60) as large as possible with respect to the external diameter and obtaining the maximum possible travel of the control coil (60) with respect to the magnetic assembly (3) in accordance to the total thickness of the coil (60) and the magnetic assembly (3).

The coil (60) has height lower than the height of the enclosure (7) of the magnetic assembly, in such manner that the coil (60) is underhung and can be moved with a certain travel in the magnetic field generated by the magnetic assembly (3).

The position of the support (9) and the control coil (60) in the external peripheral part with respect to the magnetic assembly (3) allows for the effective dissipation of the heat generated by the electrical current that circulates in the control coil (60). This allows for circulation in the control coil (60) of intense currents that correspond to high powers of the transducer, without excessive temperature values that may damage the coil (60), the support (9) of the coil and the elastic suspension (40).

Referring to FIG. 4 shows a position occupied by the control coil (60) when it is excited by an especially strong signal. The control coil (60) can move outside the volume of the enclosure (7) of the magnetic assembly, moving towards the elastic suspension (40). In particular, the upper end of the coil (60) can enter inside the loop (41) of the elastic suspension, without interfering with the elastic suspension.

When the proportions of the magnets (30) are similar to the ones of FIG. 2C (height higher than width), in the region above the enclosure (7) of the magnetic assembly, the magnetic assembly inverts its direction and therefore transmits a braking force that dampens the mechanical over-travel of the control coil (60) connected to the suspension (40), thus preventing the control coil (60) from stopping against the elastic suspension (40).

Instead, when the electromagnetic braking is not desired, proportions of the magnets such as in FIG. 2D (width higher than height), can be used, to allow the coil for intercepting a residual flux that is still useful for the axial movement, the sign of which has not been inverted yet, and is therefore not capable of transmitting a braking force such as the one obtained with the magnets of FIG. 2C.

Therefore, the use of magnets such as the ones of FIG. 2C allows for large axial travels of the control coil (60) with consequent large mechanical energy that is useful to dampen strong vibrations, while maintaining reduced axial dimensions of the vibration control system (100) and avoiding damaging the elastic suspension (40). In this way, linear travels of the mobile parts are obtained, which had never been obtained before in such thin transducers.

Moreover, the small mobile surface (the control coil (60) or the magnetic assembly (3)), which is acoustically radiant and shaped as a thin crown, has a geometry with low mechanical/acoustic impedance that is not combined well with air and therefore resolves the spurious effect, which is common to typical inertial systems, characterized by a secondary emission of acoustic kind also when not expressly desired.

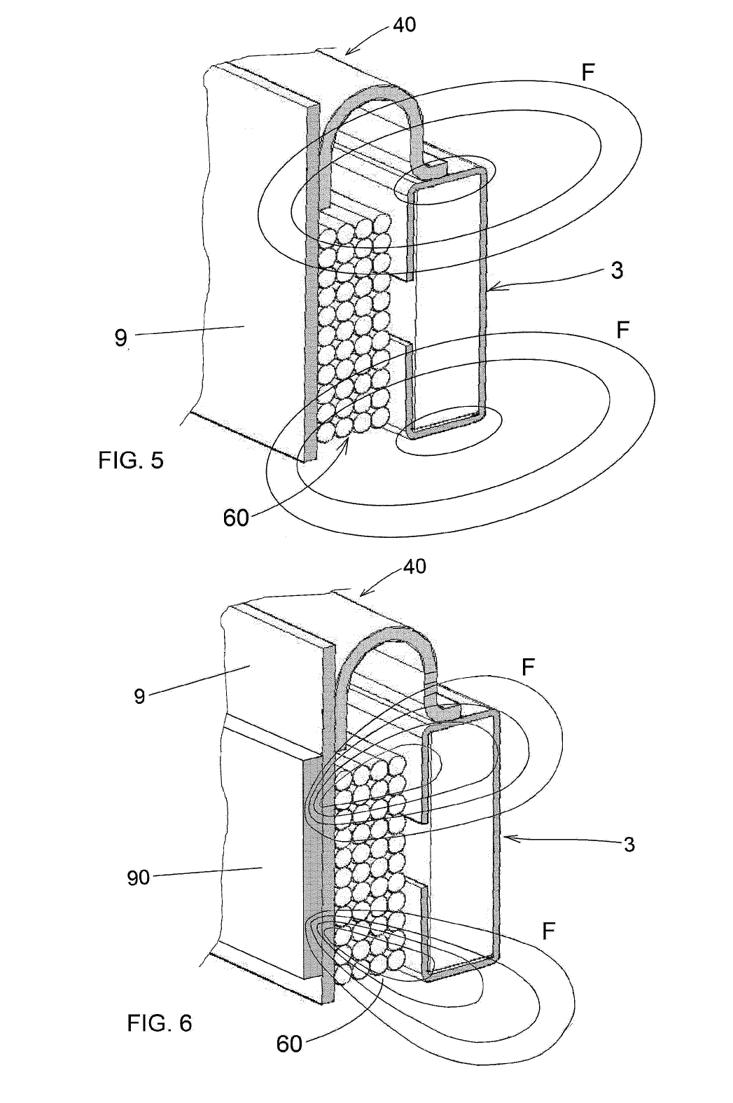

FIG. 5 shows the trend of the magnetic fluxes generated by the magnetic assembly (3). Given the fact that each magnet (30) has axial magnetization, the magnetic flux lines (F) on the vertical axis are basically disposed in perpendicular position to the external side of the enclosure (7) of the magnetic assembly, i.e. perpendicular to the side of the enclosure facing towards the control coil (60).

FIG. 6 shows a solution to concentrate the magnetic field on the control coil (60). In such a case a concentrator ring (90) made of highly magnetic permeable material is disposed on the control coil (60). The concentrator ring (90) is fixed to the external surface of the support (9) of the control coil. In this way, the magnetic flux lines (F) are deformed and concentrated in the area of the control coil (60), increasing the intensity of the magnetic field and the efficacy of the action of the control coil (60) and consequently the response power to the electrical signal.

Because of the self-bearing structure of the magnetic assembly (3), the transducer (1) or the vibration control system (100) does not need a support basket. In any case, the transducer (1) or the vibration control system (100) can be mounted on any type of support basket or frame, such as for example the body of a car or the frame of a TV set. For such mounting, it is simply necessary to glue or fit the enclosure (7) of the magnetic assembly to the basket or frame.

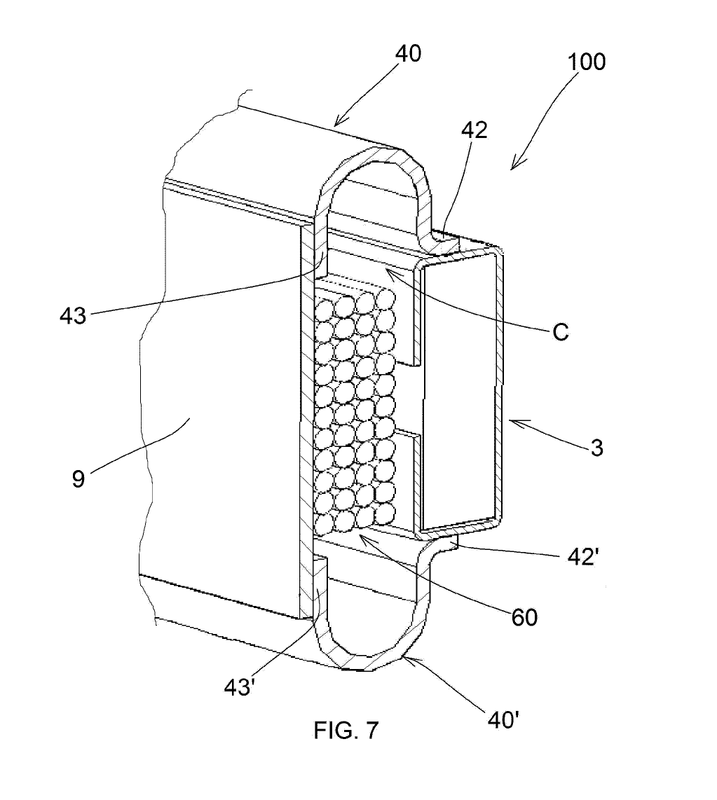

FIG. 7 shows a different version of the vibration control system (100) that comprises two elastic suspensions (40, 40′): one upper suspension (40) and one lower suspension (40′). The internal peripheral portions (42, 42′) of the two suspensions are fixed to the magnetic assembly (3). Instead, the external peripheral portions (43, 43′) of the two suspensions are fixed to the support (9) of the control coil.

Such a vibration control system comprising two elastic suspensions (40, 40′) is very strong and balanced and in spite of the total low thickness, it allows for obtaining a loudspeaker with high electromechanical power provided with high axial mechanical control.

Between the support (9) of the coil and the magnetic assembly (3) and the two elastic suspensions (40, 40′) a closed chamber (C) is generated, which may impair the heat dissipation of the coil (60). In such a case, the internal peripheral borders (42, 42′) of the elastic suspension can be spaced from the enclosure (7) of the magnetic assembly, by means of suitable discontinuous spacers that allow for air inlet inside the chamber (C) and vice versa, thus providing for ventilation of the chamber (C). The same ventilation effect can be obtained by drilling holes on the support (9) of the control coil (60).

The present invention allows for obtaining vibration control systems (100) that are thin and light, with minimum spurious acoustic effect, without impairing the electrical and mechanical power of the transducer. Moreover, it is possible to obtain transducers with large dimensions, i.e. large diameters, but with very low total depth, while maintaining the high travel of the mobile parts, thus providing a high electro-mechanical power while maintaining a thin crown profile to prevent the spurious acoustic component.

The use of a plurality of magnets (30) instead of a single magnet allows for obtaining very large magnetic rings with any diameter, yet with very small crown thickness, starting from the same single magnet with small dimensions. The magnetic assembly (3) allows for obtaining very deep magnetic fields, providing for very high travels of the control coil (60) completely immersed in the magnetic field (underhung) and without using additional iron magnetic circuits, thus preventing the generation of distortion caused by the iron electromagnetic modulation. The combination of many small magnets (30) side by side allows for obtaining magnetic fields of any perimeter shape from simple axial magnetizations. The magnetic assembly (3) can have any perimeter shape (circular, elliptical, square, rectangular, etc.), allowing the transducer to have all shapes for uses that require special shapes, such as ultraflat TVs.

If necessary, the magnetic assembly (3) allows for obtaining a new configuration of the control coil (60). As show in FIG. 6, the control coil (60) is wound in the proximity of a thin layer of highly magnetic permeable material (9) that allows for conveying the flux lines of the magnetic field on all the windings of the coil, thus increasing the electromechanical efficiency of the system. Being thin, the ferromagnetic layer (9) prevents the formation of parasite currents that would impair the behavior of the transducer. The ferromagnetic ribbon (9) whereon the coil is wound can have a higher height than the winding of the control coil (60), thus allowing for immersing the entire coil in the concentrated magnetic flux-underhung-(in similar solutions, only the central art of the coil sees the concentrated flux-overhang-derived from repulsive magnetic systems provided with iron polar expansions).

With the same external diameter, the electromagnetic transducer (1) of the invention has a higher radiant surface of the membrane (5) compared to the transducers of the prior art. Moreover, it has constructive advantages: in fact, the use of small magnets (30) allows for making tubular rings with any shape and very low thickness, which would be otherwise impossible to obtain. For the purposes of the present invention, the use of small magnets with axial anisotropy is necessary compared to the use of magnets with radial anisotropy because the first (axial) ones allow from obtaining magnetic circuits with all shapes and sizes from the same magnet, which are easy to magnetize, whereas the second (radial) ones only allow for obtaining the circular shape with only one diameter from the same magnet, expressly requiring special magnetization of radial type that are very expensive and impossible on large diameters.

1. Electromagnetic transducer comprising:
a ring magnetic assembly that generates a magnetic field,
a first coil disposed in the magnetic field generated by the magnetic assembly such that the first coil reciprocally moves with respect to the magnetic assembly or vice versa,
at least one elastic suspension connecting the magnetic assembly to the first coil to allow for reciprocal movement between the first coil and the magnetic assembly,
a control coil connected to the magnetic assembly by means of an elastic suspension to allow for reciprocal movement of the control coil with respect to the magnetic assembly,
a vibrating surface connected to the first coil or the magnetic assembly or the control coil in order to vibrate, and
an electronic control to control an excitation current of said control coil in order to generate a mechanical force adapted to control the mechanical vibration of said vibrating surface.

2. The transducer of claim 1, wherein said control coil and its elastic suspension are shaped as a thin annular crown in such manner to have minimum acoustically radiant surface to prevent spurious generation of acoustic signal.

3. The transducer of claim 1, wherein said control coil is disposed in opposite position to the first coil with respect to the magnetic assembly.

4. The transducer of claim 3, wherein the first coil is disposed inside said ring of the magnetic assembly and the control coil is disposed outside said ring of the magnetic assembly.

5. The transducer of claim 1, wherein the transducer comprises a support for said control coil, wherein said support is made of non-ferromagnetic material and comprises a concentrator ring made of highly magnetic permeable material to concentrate the magnetic field on all turns of the control coil.

6. The transducer of claim 1, wherein said elastic suspension connecting the control coil to the magnetic assembly is a portion of the elastic suspension that connect the magnetic assembly to the first coil.

7. The transducer of claim 1, wherein the transducer comprises an upper elastic suspension and a lower elastic suspension connecting said control coil to said magnetic assembly.

8. The transducer of claim 1, wherein said magnetic assembly is fixed to a fixed surface and said control coil is mobile with respect to the magnetic assembly.

9. The transducer of claim 1, wherein said magnetic assembly comprises:
an enclosure with annular shape made of non-ferromagnetic material, and
a plurality of magnets with a magnetic axis and axial anisotropy; said magnets being disposed side by side inside said enclosure and each magnet having magnetic flux lines mutually parallel and parallel to the magnetic axis of magnet,
wherein said enclosure of magnetic assembly acts as confinement structure for magnets and the magnetic axis of magnets is directed towards the center of the ring formed by enclosure.

10. The transducer of claim 9, wherein said enclosure is a support structure acting as bearing structure for the transducer.
